(19) United States
(12) Patent Application Publication
(10) Pub. No.: US 2023/0384195 A1
(43) Pub. Date: Nov. 30, 2023

(54) AN APPARATUS AND METHOD TO MEASURE SPEED OF SOUND AND DENSITY OF A FLUID

(71) Applicant: Corvera, LLC, South Glastonbury, CT (US)

(72) Inventor: Daniel Gysling, South Glastonbury, CT (US)

(73) Assignee: Corvera, LLC, South Glastonbury, CT (US)

(21) Appl. No.: 18/249,575

(22) PCT Filed: Oct. 20, 2021
(86) PCT No.: PCT/US21/55758

§ 371 Date: Apr. 19, 2023

Related U.S. Application Data
(60) Provisional application No. 63/198,462, filed on Oct. 20, 2020.

(51) Int. Cl. G01N 9/00; G01N 9/24

(52) U.S. Cl. CPC G01N 9/002; G01N 9/24

(57) ABSTRACT

A vibrating plate densitometer system and methods are disclosed that can provide information related to the density of a fluid in a vessel. Also disclosed are apparatus and methods to determine the speed of sound of the fluid and methods for designing such apparatus. Embodiments of the present disclosure include systems and methods to measure such parameters including the density, or the density and the entrained air, of wet concrete within a vessel. The present disclosure also provides means for maintaining accurate measurement that exploits the rotating nature of many vessels that contain concrete.

### CROSS REFERENCE TO RELATED APPLICATIONS

This application claims the benefit of U.S. Provisional Patent Application Ser. No. 63/198,462 having a filing date of 20 Oct. 2020. The disclosure of the application above is incorporated herein by reference in its entirety.

### BACKGROUND OF THE DISCLOSURE

### Field of the Disclosure

The present disclosure relates to determining the parameters related to amounts of entrained gases, density and sound speed of a fluid within a vessel.

### Description of the Related Art

The measuring of the amount of entrained air and the density of a fluid within a vessel is important in many industrial applications. One such application is the measurement of concrete properties in a rotating drum of a concrete delivery truck. There exist several attempts in the prior art to sense certain parameters related to the physical characteristics of concrete in the rotating drum of a concrete delivery truck. Some techniques in the prior art lack precise characterization of the physical properties of concrete, and other suffer deleterious effects caused by the abrasive nature of the concrete slurries, for which insertion-type density measuring probes or flow-through-type density measurement devices which can get damaged or clogged by particles within the slurry.

The examples of the prior art lack the ability to provide robust methods techniques to determine parameters related to a fluid within a vessel, such as a rotating drum, in an accurate, fast and efficient way. For at least the reasons stated herein before, it is desirable to provide a system and method that alleviates the known problems of the prior art.

### SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a fluid density measurement device that includes a housing, a plate mounted to the housing around a periphery of the plate forming an interior space within the housing, a first side of the plate is configured to be placed in fluid communication with a first fluid to produce a fluid loaded plate, an actuator coupled to the plate and configured to drive the fluid loaded plate in a transverse direction and produce a vibratory motion of the fluid loaded plate in the transverse direction, a sensor configured to detect the vibratory motion of the fluid loaded plate, the actuator further configured to produce the vibratory motion at or near a natural frequency of the fluid loaded plate, and a computer processor configured to determine a density of the first fluid based at least in part in dependance of the natural frequency of the fluid loaded plate. Other embodiments of this aspect include corresponding computer systems, apparatus, and computer programs recorded on one or more computer storage devices, each configured to perform the actions of the methods.

Implementations may include one or more of the following features. The fluid density measurement device may include a feedback control system in communication with the actuator and the sensor configured to control the actuator to generate the vibratory motion of the fluid loaded plate at or near the natural frequency of the fluid loaded plate in response to a measurement signal of the sensor, the computer processor further configured to determine a simulated natural frequency of the fluid loaded plate, and determine the density of the first fluid in dependance of a measured natural frequency of the fluid loaded plate and the simulated natural frequency of the fluid loaded plate. The fluid density measurement device may include a sound speed measurement device configured to determine a measured sound speed of the first fluid, and the computer processor is further configured to determine the density of the first fluid in dependence of the measured natural frequency of the fluid loaded plate and the measured sound speed of the first fluid. The fluid density measurement device may include the computer processor is configured to determine a gas void fraction of the first fluid in dependence of the measured sound speed of the first fluid and the density of the first fluid. The second fluid has a second impedance that is much lower than a first impedance of the first fluid. The actuator may include a drive coil and the sensor may include a pick-off coil. The vibratory motion is driven to a limit cycle oscillation. The fluid density measurement device may include a feedback control system in communication with the actuator and the sensor configured to control the actuator to generate the vibratory motion in the fluid loaded plate in response to a measurement signal of the sensor and to measure a measured control parameter required to sustain the vibratory motion of the fluid loaded plate at or near the natural frequency of the fluid loaded plate, the computer processor further configured to use a model to relate at least one of the density of the first fluid and a sound speed of the first fluid to a predicted control parameter required to sustain the vibratory motion of the fluid loaded plate at or near the natural frequency of the fluid loaded plate, use the model to relate at least one of the density of the first fluid and the sound speed of the first fluid to a predicted natural frequency of the fluid loaded plate, and compare the predicted control parameter to the measured control parameter and the predicted natural frequency to the natural frequency and to determine at least one of an actual sound speed of the first fluid and an actual fluid density of the first fluid. The computer processor is further configured to determine an entrained air content of the first fluid in dependence of at least one of the sound speed of the first fluid and the density of the first fluid. The fluid density measurement device may include a frame attached to the housing and configured to be mounted to an opening in a vessel. Implementations of the described techniques may include hardware, a method or process, or computer software on a computer-accessible medium.

One general aspect includes a fluid density measurement system that includes a vessel having an outer wall and a first fluid disposed therein, a plate positioned in an opening in the outer wall having a first side placed in fluid communication with the first fluid, an actuator coupled to the plate and configured to drive the plate in a transverse direction and produce a vibratory motion of the plate in the transverse direction, a sensor configured to detect the vibratory motion of the plate, the actuator further configured to produce the vibratory motion at or near a natural frequency of the plate, and a computer processor electrically coupled to the actuator and the sensor and configured to determine a density of the first fluid based at least in part in dependance of the natural frequency of the plate. Other embodiments of this aspect include corresponding computer systems, apparatus, and computer programs recorded on one or more computer storage devices, each configured to perform the actions of the methods.

Implementations may include one or more of the following features. The fluid density measurement system may include a housing, a frame mounted to the housing, the plate mounted to the housing around a periphery of the plate forming an interior space within the housing, and the frame mounted to the outer wall. The fluid density measurement system may include a sound speed measurement device configured to determine a measured sound speed of the first fluid, and the computer processor is further configured to determine the density of the first fluid in dependence of the natural frequency of the plate and the measured sound speed of the first fluid. The fluid density measurement system may include the computer processor is configured to determine a gas void fraction of the first fluid in dependence at least one of the measured sound speed of the first fluid and the density of the first fluid. The second fluid has a second impedance that is much lower than a first impedance of the first fluid, the actuator and the sensor are disposed within the interior space, and where the actuator may include a drive coil and the sensor may include a pick-off coil. The vibratory motion is driven to a limit cycle oscillation. the fluid density measurement system may include a feedback control system in communication with the actuator and the sensor configured to control the actuator to generate the vibratory motion of the plate at or near the natural frequency of the plate in response to a measurement signal of the sensor, the computer processor further configured to determine a simulated natural frequency of the plate, and determine the density of the first fluid in dependance of a measured natural frequency of the plate and the simulated natural frequency of the plate. The fluid density measurement system may include a feedback control system in communication with the actuator and the sensor configured to control the actuator to generate the vibratory motion in the plate in response to a measurement signal of the sensor and to measure a measured control parameter required to sustain the vibratory motion of the plate at or near the natural frequency of the plate, the computer processor further configured to use a model to relate at least one of the density of the first fluid and a sound speed of the first fluid to a predicted control parameter required to sustain the vibratory motion of the plate at or near the natural frequency of the plate, use the model to relate at least one of the density of the first fluid and the sound speed of the first fluid to a predicted natural frequency of the plate, and compare the predicted control parameter to the measured control parameter and the predicted natural frequency to the natural frequency and to determine at least one of an actual sound speed of the first fluid and an actual fluid density of the first fluid. The computer processor is further configured to determine an entrained air content of the first fluid in dependence of at least one of the sound speed of the first fluid and the density of the first fluid. Implementations of the described techniques may include hardware, a method or process, or computer software on a computer-accessible medium.

One general aspect includes a method of determining a density of a process fluid. The method also includes providing a vessel having an exterior wall and the process fluid disposed therein, positioning a plate in the exterior wall having a first side of the plate in fluid communication with the process fluid, producing a vibratory motion of the plate in a transverse direction, detecting the vibratory motion of the plate, producing the vibratory motion at or near a natural frequency of the plate, and determining a density of the process fluid based at least in part in dependance of the natural frequency of the plate. Other embodiments of this aspect include corresponding computer systems, apparatus, and computer programs recorded on one or more computer storage devices, each configured to perform the actions of the methods.

Implementations may include one or more of the following features. The method of determining a density of a process fluid may include coupling at least one sensor and an actuator to the plate, providing a feedback control system in communication with the sensor, controlling the vibratory motion of the plate at or near the natural frequency of the plate in response to a measurement signal from at least one sensor, determining a simulated natural frequency of the plate, measuring a natural frequency of the plate using the at least one sensor, and determining the density of the process fluid in dependance of a measured natural frequency of the plate and the simulated natural frequency of the plate. The method of determining a density of a process fluid may include providing a sound speed measurement device and determining a measured sound speed of the process fluid, and determining the density of the process fluid in dependence of the measured natural frequency of the plate and the measured sound speed of the process fluid. The method of determining a density of a process fluid further determining a gas void fraction of the process fluid in dependence of at least one of the measured sound speed of the process fluid and the density of the process fluid. The method of determining a density of a process fluid may include driving the vibratory motion to a limit cycle oscillation. The method of determining a density of a process fluid may include coupling at least one sensor to the plate, providing a feedback control system in communication with the at least one sensor, generating the vibratory motion in the plate in response to a measurement signal from the at least one sensor measuring a measured control parameter required to sustain the vibratory motion of the plate at or near the natural frequency of the plate, using a model to relate at least one of the density of the process fluid and a sound speed of the process fluid to a predicted control parameter required to sustain the vibratory motion of the plate at or near the natural frequency of the plate, using the model to relate at least one of the density of the process fluid and the sound speed of the process fluid to a predicted natural frequency of the plate, comparing the predicted control parameter to the measured control parameter and the predicted natural frequency to the natural frequency, and determining at least one of an actual sound speed of the process fluid and an actual fluid density of the process fluid. The method of determining a density of a process fluid may include determining an entrained air content of the process fluid in dependence of at least one of the actual sound speed of the process fluid and the actual fluid density of the process fluid. Implementations of the described techniques may include hardware, a method or process, or computer software on a computer-accessible medium.

One general aspect includes a method of determining fluid properties of an aerated process fluid. The method of determining fluid properties also includes providing a vessel having an exterior wall and the aerated process fluid disposed therein, positioning a plate in the exterior wall having a first side of the plate in fluid communication with the aerated process fluid, measuring a natural frequency of the plate, measuring a sound speed of the aerated process fluid, and determining a mixture density of the aerated process fluid using the natural frequency of the plate and the sound speed of the aerated process fluid. Other embodiments of this aspect include corresponding computer systems, apparatus, and computer programs recorded on one or more computer storage devices, each configured to perform the actions of the methods.

Implementations may include one or more of the following features. The method of determining fluid properties of an aerated process fluid may include determining a pressure of the aerated process fluid, and determining a gas void fraction of the aerated process fluid using the mixture density of the aerated process fluid and the pressure of the aerated process fluid. The method of determining fluid properties of an aerated process fluid may include determining a density of a liquid portion of the aerated process fluid using the density of the aerated process fluid and gas void fraction of the aerated process fluid. Implementations of the described techniques may include hardware, a method or process, or computer software on a computer-accessible medium.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic cross sectional view of a vibrating plate densitometer positioned within a wall of vessel containing a fluid in accordance with the present disclosure;

FIG. 2 is a graphical representation of the specific resistance of a circular piston embedded in a rigid wall of the prior art;

FIG. 3 is a graphical representation of the specific reactance of a circular piston embedded in a rigid wall of the prior art;

FIG. 4 is a graphical representation of the resonant frequency of a VPD in accordance with the present disclosure;

FIG. 5 is a graphical representation of the acoustic damping of a VPD in accordance with the present disclosure;

FIG. 6 is a graphical representation of the normalized piston radius of a VPD in accordance with the present disclosure;

FIG. 7 is a graphical representation of the resonant frequency of a VPD in accordance with the present disclosure;

FIG. 8 is a graphical representation of the acoustic dampening of a VPD in accordance with the present disclosure;

FIG. 9 is a graphical representation of the normalized piston diameter of a VPD in accordance with the present disclosure;

FIG. 10 is a graphical representation of the resonant frequency as a function of fluid impedance for various fluids of a VPD in accordance with the present disclosure;

FIG. 12 is a graphical representation of the damping ratio as a function of fluid density of a VPD in accordance with the present disclosure;

FIG. 13 is a graphical representation of the normalized piston radius as a function of fluid density of a VPD in accordance with the present disclosure;

FIG. 14 is a schematic representation of a vibrating plate density measurement and a process fluid sound speed measurement in accordance with the present disclosure;

FIG. 15 is a graphical representation of contour plot of an error function of a VPD in accordance with the present disclosure;

FIG. 16 is a schematic representation of a vibrating plate density measurement system to determine process fluid density and sound speed in accordance with the present disclosure;

FIG. 17 is a cross sectional representation of a vibrating plate density measurement system positioned in a rotating vessel in accordance with the present disclosure;

FIG. 18 is a cross sectional representation of a vibrating plate density measurement system positioned in a rotating vessel in accordance with the present disclosure;

FIG. 19 a graphical representation of the specific resistance of an embodiment of a VPD in accordance with the present disclosure;

FIG. 20 a graphical representation of the specific reactance of an embodiment of a VPD in accordance with the present disclosure;

FIG. 21 is a graphical representation of contour plot of an error function of an embodiment of a VPD in accordance with the present disclosure; and

FIG. 22 is a side view of a concrete truck including a VPD in accordance with the present disclosure.

### DETAILED DESCRIPTION

In the following detailed description of the embodiments, reference is made to the accompanying drawings, which form a part hereof, and within which are shown by way of illustration specific embodiments by which the examples described herein may be practiced. It is to be understood that other embodiments may be utilized and structural changes may be made without departing from the scope of the disclosure.

Measuring certain parameters of wet concrete such as the entrained air content and/or density is important to monitor and ensure the quality of concrete. Embodiments of the present disclosure include systems and methods to measure such parameters including the density, or the density and the entrained air, of wet concrete within a vessel. The present disclosure also provides means for maintaining accurate measurement that exploits the rotating nature of many vessels that contain concrete. While the context of this disclosure addresses wet concrete, the systems and methods disclosed are not so limiting and are applicable to measuring the density, and or density and entrained gas, in a wide range of other fluids contained within vessels. In addition, the systems and methods disclosed overcome difficulties found in the prior art in that they are well-suited for abrasive slurries for which insertion-type density measuring probes or flow-through-type density measurement devices can get damaged or clogged by particles within the slurry.

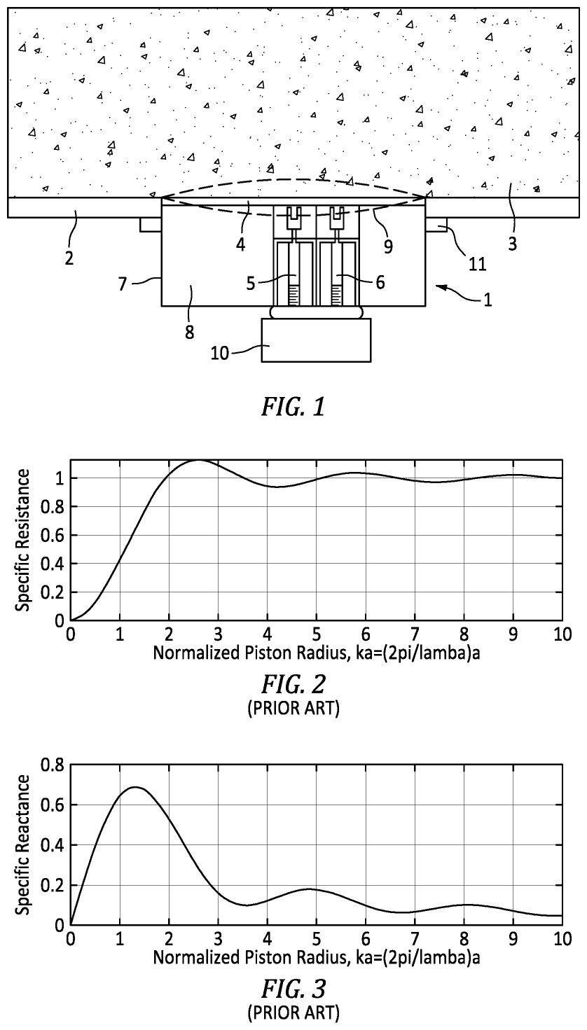

Referring to FIG. 1, there is shown a fluid density measurement device in the form of VPD 1 mounted to an exterior wall 2 of a vessel containing a fluid 3 such as a concrete slurry. VPD 1 is comprised plate 4, drive coil 5 coupled to the plate, pick off coil 6 coupled to the plate and housing 7. Plate 4 is mounted around its periphery to housing 7 and together they define a closed interior space 8 preferably filled with a low impedance fluid (i.e. a gas) or a vacuum within which drive coil 5 and pick off coil 6 are positioned. One skilled in the art should appreciate that plate 4 of VPD 1 can be considered to be a vibrating plate that is exposed to a relatively high impedance mixture (e.g., placed in fluid communication with a fluid 3 or slurry mixture such as concrete or other process fluid) on one side (the inside surface) and a relatively low impedance mixture (e.g., a gas) on the other side (the inside surface) within interior space 8. As such, the vibrational characteristics of the plate are predominantly influenced by the properties of the relatively high impedance fluid. Plate 4 of vibrating plate densitometer 1 is driven in a vibratory mode by drive coil 5 in a transverse direction in and out of the plane defined by exterior wall 2 within vibratory envelope 9. The motion of the plate 4 while vibrating within vibratory envelope 9 is detected by a pick-off coil 6, which measures the time-accurate, nearly sinusoidal velocity of the plate and produces a measurement signal relating thereto. It should be noted that although the sensor sensing the motion of plate 4 is shown as pick off coil 6, it can comprise other devices such as an accelerometer, a proximity sensor or a strain gauge without departing from the present disclosure. In certain embodiments plate 4 is circular in shape and supported around it's outer circumference by the essentially planar and essentially rigid exterior wall 2 of a vessel containing the concrete slurry. When positioned as shown, one surface of plate 4 is in contact with slurry 3, and the other side is in contact with a low impedance gas, or vacuum within interior space 8. Because plate 4 is an essentially two-dimensional flexible plate support around its circumference, it can support transverse vibrations within vibratory envelope 9. Note also It should be appreciated by those skilled in the art that the vibrating plate could also be a plate supported by a flexible diaphragm connecting the outer circumference of the plate the essentially rigid wall of the vessel. The important physical characteristics of VPD 1 as part of a fluid 3 containing vessel system are that fluid loaded plate 4 has a transverse, piston-like vibratory motion and that the vibratory plate and the wall 2 of the vessel are essentially sealed so as to effectively contain the fluid within the vessel. Feedback control module 10 is in communication with drive coil 5 and pick off coil 6 to control vibrating plate 4 as will disclosed in more detail herein after. Further, feedback control module can include analog devices and digital devices including computers, computer processors and microprocessors all of which are configured to control various aspects of the current disclosure.

Plate 4 is similar to the properties of an idealized drumhead and can be modeled by the vibrations of a circular plate of uniform thickness, attached to a rigid frame 11. i.e. outer wall 2 of the vessel, commonly referred to as drum modes of the plate. In the embodiment shown, and ignoring damping effects, and wherein interior space 8 is comprised of a vacuum, and the vessel is “empty”, and there is no force applied to the plate by the drive coil, the in-vacuum equations of motion for vibrating plate 4 can be expressed as a simple mass-spring system for the first, drum mode of the system:

M\ddot{x}+K_{S}x=0 (Equation 1)

Where M is the modal mass of the first drum mode of the plate, and K_{S} is the modal stiffness of said mode. The natural frequency of the drum mode in-vacuum of a plate 4 of constant thickness, clamped around its circumference to outer wall 2 has been solved in the prior art and can be determined in dependance of the parameters given by Equation 2:

$${ω}_{n} = β \sqrt{\frac{{Et}^{2}}{{ρ}_{s} {a}^{4} ( 1 - {v}^{2} )}} = \sqrt{\frac{{K}_{s}}{M}} \qquad ( Equation 2 )$$

Where β=11.84 can be used for the first drum mode. The natural frequency of thin plates having a uniform thickness can be determined using prior art calculators such as the one found at the following web address https://www.engineersedge.com/vibration/thin_flat_plates_uniform_thickness_14986.ht m. In addition, β=11.84 is given in Blevins, “Formulas for Natural Frequency and Mode Shapes”, specifically at Table 11-1, Circular Plates, Section 3, Clamped Edge, i (nodal diameter)=0, j (nodal circumference)=1). As part of the present disclosure, the use of β=11.84 for example calculations can be done without any loss of generality.

It should be appreciated by those skilled in the art that these relationships are used as a baseline for the stiffness and natural frequency properties of a circular plate. In addition, structural mass can be added to the center of the plate 4 to effectively increase the mass of the plate without materially impacting the stiffness of the plate, thereby reducing the in-vacuum nature frequency and thus providing design flexibility to provide desired dynamical characteristics of the fluid-loaded vibrating plate densitometer 1.

The acoustic impedance of a fluid is defined as the product of the speed of sound of the fluid and the density of the fluid and is considered an intrinsic property of a fluid. For bubbly fluids, the sound speed associated with the impedance of the bubbly fluid is the sub-bubble-resonant speed, associated the speed of sound for frequencies for which the wavelength is significantly longer than the length scale of inhomogeneities with in the fluid. The impedance of a fluid represents the ratio of the acoustic pressure oscillations to the acoustic velocity oscillation in a propagating planar acoustic wave.

By modelling the motion of the drum mode of the plate as a piston embedded in a infinite wall, the effect of the fluid loading on the inside surface can be incorporated as follows:

M\ddot{x}+Kₛx=−pA=−(θ₀−iψ₀)ρċx(πa²) (Equation 3)

Where θ₀ and ψ₀ are the resistive and the reactive components, respectively, of the specific acoustic impedance of the fluid 3 acting on the vibrating plate 4. This formulation recognizes that the fluid loading of a piston imbedded within a wall will, in general, differ in both magnitude and phase, than the fluid loading associated with a piston driving a pure planar wave propagating away from the piston, for which the reactive part of the specific impedance would be zero, and the resistive part of the specific impedance would be unity.

The resistive part of the impedance, θ₀, represents the component of pressure that is in phase with the plate velocity, and the reactive component impedance, ψ₀, represents the component of pressure that is out of phase with the plate velocity. The resistive and reactance components of the specific impedance for a circular piston embedded in a wall (or baffle) has been solved for and tabulated in the prior art by Morse and Ingard, in “Theoretical Acoustics” by Princeton University Press (ISBN 10: 0691024014).

With reference to FIGS. 2, 3 the resistive and reactive components of the specific impedance of the fluid acting on a piston in a baffle, from Morse and Ingard, are plotted as a function of normalized piston radius. In this regard, the normalized piston radius is defined as the product of the acoustic wavenumber, k, and the radius of the piston, a. It should be appreciated by those skilled in the art that the normalized piston radius is equivalent to the circumference of the piston divided by the acoustic wavelength. As indicated in FIGS. 2, 3, the both the real and imaginary components of the specific impedance of the fluid on the piston approaches zero as the normalized piston radius approaches zero. For large values of the normalized piston radius for which the radius is large compared to the wavelength, the specific resistance approaches unity (FIG. 2), and the reactance approaches zero (FIG. 3). Thus, for large normalized piston radii, the impedance of the fluid on the piston approaches that of a planar wave. The specific impedance is shown to be relatively highly sensitive to the normalized piston radius in the range of normalized piston radii from approximately 0.5 to approximately 3.

Holding all other parameters constant, i.e. the size of the piston 4, and the speed of sound of the process fluid, but varying frequency, the normalized piston radius increase with frequency. In the limit of low frequencies, the wavelength is long compared to the piston radius, and the normalized piston radius approaches zero, and, as indicated in FIGS. 2, 3, both the specific reactive and resistive impedance acting on the piston 4 approach zero. As the frequency increases, the wavelength becomes smaller, and the normalized piston radius becomes larger. For normalized piston radii much greater than unity, the reactive specific impedance acting on the piston approaches zero, and the resistive specific impedance acting on the piston approaches unity, approaching the condition of a piston drive a planar wave propagating away from the piston 4

Rearranging Equation 3, and assuming harmonic motion of vibrating plate 4 the amplitude of the plate can be expressed as follows:

x=real(Xe^{iωt}) (Equation 4)

It follows that the equation of motion for the drum mode of the fluid-loaded plate 4, including the mass loading from the reactance, but neglecting the acoustic damping from the resistive component of the fluid loading and neglecting any structural or mechanical damping, can be expressed as follows:

$$( ( M + \frac{π {a}^{2} ρ c {ψ}_{0} ( ka )}{ω} ) {ω}^{2} + {K}_{s} ) X = 0 \qquad ( Equation 5 )$$

Where the effective mass of the fluid 3 on the structure of plate 4 is given by:

$${M}_{eff} ≡ \frac{π {a}^{2} ρ c {ψ}_{0} ( ka )}{ω} \qquad ( Equation 6 )$$

It should be appreciated by those skilled in the art that the effective mass is a function of the radius of the piston (α); the density of the fluid (ρ); the sound speed of the fluid (c); the frequency of the vibration (ω); and the specific reactance (ψ₀).

The natural frequency of the fluid-loaded plate can be determined in dependance of the variables below by solving the following Eigenvalue problem for the frequency of the vibration of plate 4:

$$( ( M + \frac{π {a}^{2} ρ c {ψ}_{0} ( ka )}{ω} ) {ω}^{2} + {K}_{s} ) = 0 \qquad ( Equation 7 )$$

The Eigenvalue problem can be solved numerically by defining a positive-definite error function and minimizing the error as a function of trial natural frequency (or simulated natural frequency) in accordance with the following:

$$error ( {ω}_{trial} ) = {( ( M + \frac{π {a}^{2} ρ c {ψ}_{0} ( \frac{{ω}_{trail}}{c} a )}{{ω}_{trail}} ) {ω}_{trail}^{2} + {K}_{s} )}^{2} \qquad ( Equation 8 )$$

Where the wavenumber has been replaced the ratio of the trial frequency and the sound speed of the fluid.

This approach can be used to determine the natural frequency for a given piston with given in-vacuum vibrational characteristics, loaded with a fluid of known sound speed and density. Assuming that the vibrating plate remains lightly damped, as developed below in Equation 9, the acoustic damping can be readily determined once the natural frequency of the fluid-loaded plate is determined and the density can be determined at least in part using the natural frequency.

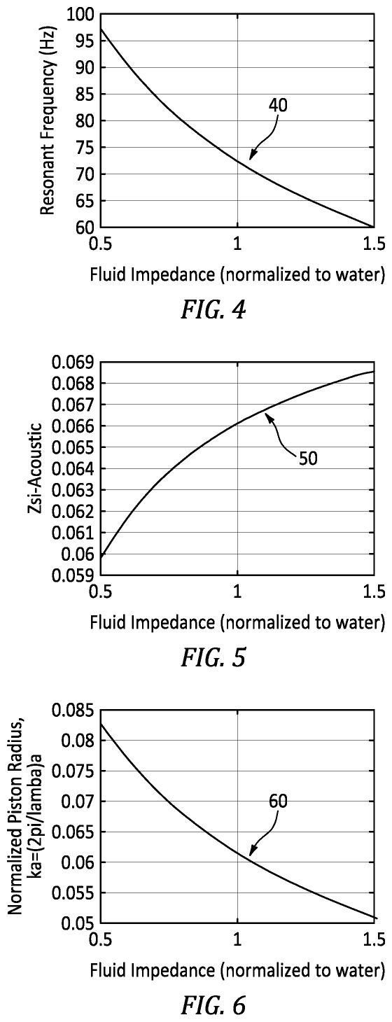

Still referring to FIG. 1 and with further reference to FIGS. 4, 5, there is shown the resonant frequency 40 and the acoustic damping 50 plotted against fluid impedance for an embodiment VPD 1. In this particular example, plate 4 comprises a circular shape having a diameter of 8 inches and a mass of 0.6575 Kgs. In addition, interior space 8 comprises a vacuum and plate 4 has an in-vacuum natural frequency of 221 Hz with the example fluid 3 having a speed of sound of 750 m/sec. The impedance of the fluid, defined as above as the product of the actual fluid density and actual sound speed, is varied in the example shown by varying the density of the fluid 3 from 1000 kg/m\hat{ }3 to 3000 kg/m\hat{ }3. Note it should be appreciated by those skilled in the art that in this approach, the natural frequency is determined utilizing the undamped equation of motion.

With further reference now to FIG. 6, there is shown the normalized piston radius (ka) 60, determined by the eigenvalue solution of Equation 8 as a function of fluid impedance for the example given above for a fluid with a sound speed of 750 m/sec and a density varying from 1000 kg/m\hat{ }3 to 3000 kg/m\hat{ }3. It should be appreciated that the normalized piston radius is below 0.1 for the range of conditions analyzed.

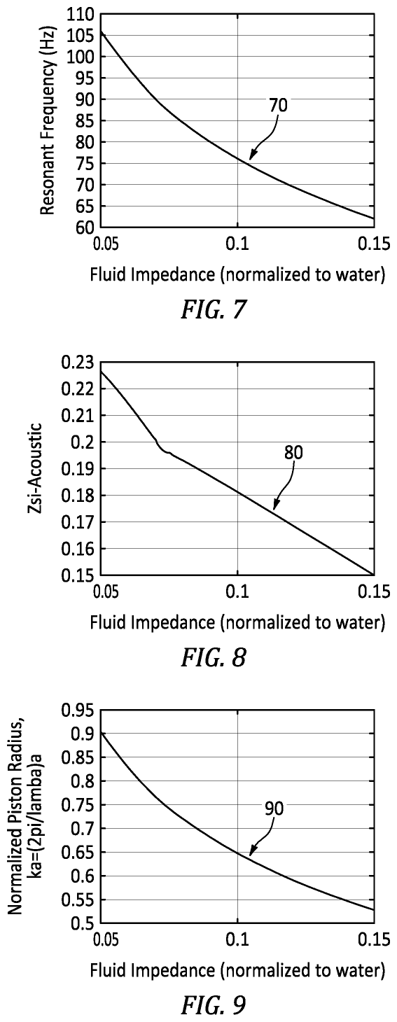

A similar set of calculations are now presented for a similar set of conditions with a fluid having a much lower speed of sound, illustrative of a concrete mixture with an elevated level of entrained air. Now with further reference to FIGS. 7, 8, there is plotted the resonant frequency 70 and the acoustic damping 80 against the fluid impedance for a fluid loaded plate 4 of VPD consistent with the example above wherein the plate has a diameter of 8, a mass of 0.6575 Kgs and an in-vacuum natural frequency of 221 Hz for a fluid 3 having a speed of sound of 75 m/sec with the actual fluid density varying from 1000 kg/m\hat{ }3 to 3000 kg/m\hat{ }3. It should be appreciated by those skilled in the art that these fluid conditions are broadly representative of wet concrete with entrained air. As shown in the graphical representations of the figures, the impedance of the liquid (i.e. the product of sound speed and density) is significantly less than the impedance of water (assuming water having a density of 1000 kg/m\hat{ }3 and a speed of sound of 1500 m/sec). The plot of FIG. 9 depicts the normalized piston radius (ka) 90, determined by the eigenvalue solution of Equation 8 as a function of fluid Impedance for a fluids with a sound speed of 75 m/sec and a density varying from 1000 kg/m\hat{ }3 to 3000 kg/m\hat{ }3, indicating the normalized piston radius is on the order of 1 for this particular example.

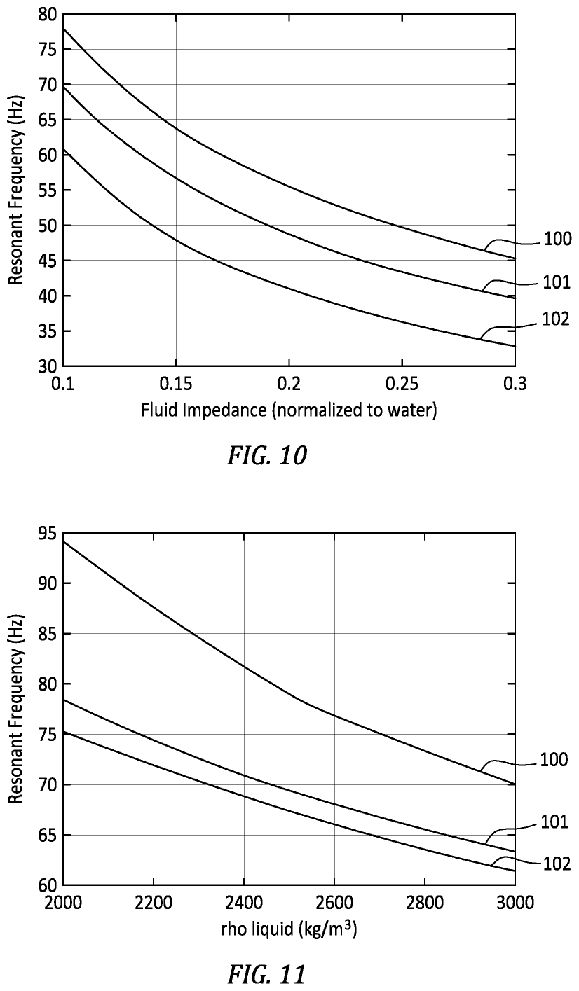

As part of the present disclosure, it should be noted that, for a given vibrating plate 4, the acoustic impedance of the fluid 3 does not uniquely determine the resonant frequency of the fluid loaded plate. Reference to FIG. 10 graphically illustrates this point, where the predicted resonant frequency of the fluid-loaded plate 4 is shown as a function of fluid impedance, normalized by the impedance of water as set forth herein above, for a first fluid 100 having a speed of sound of 40 m/s, a second fluid 101 having a speed of sound of 60 m/s and a third fluid 102 having a speed of sound of 80 m/s fluids. It should be appreciated that fluids 100-12 have sound speeds in the range of sound speeds relevant to wet concrete applications. Similarly, and with reference to FIG. 11, there is graphically depicted the resonant frequency of a fluid loaded plate 4 diameter of 8.0 inches, and an in-vacuum frequency of 221 Hz as a function of fluid density ρ for a first fluid 100 having a speed of sound of 40 m/s, a second fluid 101 having a speed of sound of 60 m/s and a third fluid 102 having a speed of sound of 80 m/s fluids.

As disclosed herein above, the resistive component of the acoustic impedance can be used to define an acoustic damping ratio ζ_{acoustic} and is given by the following expression:

$${ζ}_{acoustic} ≡ \frac{{b}_{acoustic}}{2 M {ω}_{n}} = \frac{π {a}^{2} ρ c θ ( k a )}{ω 2 M {ω}_{n}} \qquad ( Equation 9 )$$

ζ_{acoustic} would be the critical damping ratio of a fluid load plate in the absence of any mechanical damping.

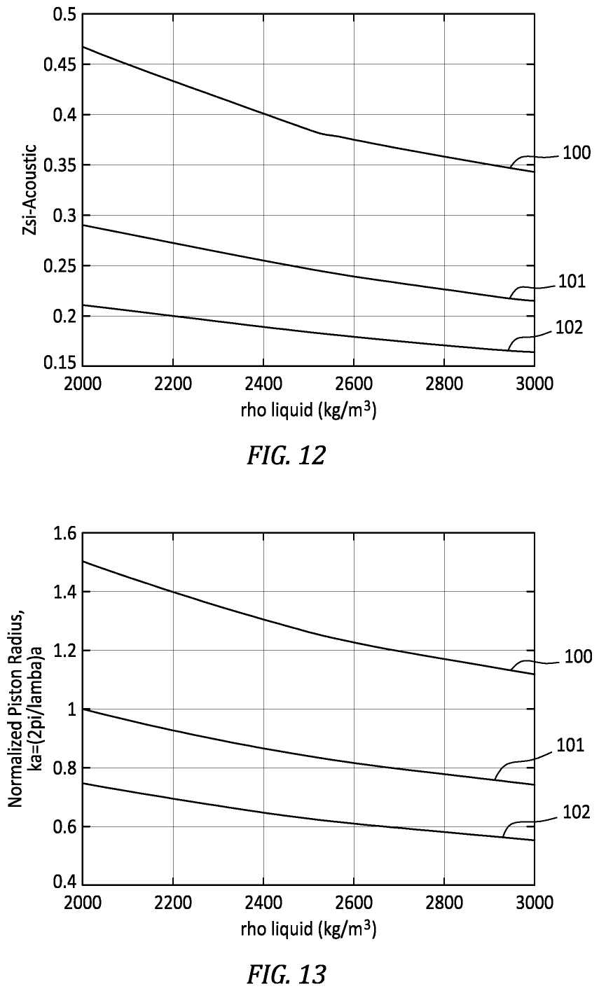

Referring to FIG. 12, from Equation 9 and following the example disclosed above, there is shown the acoustic damping ratio ζ_{acoustic} of a fluid loaded plate 4 having a diameter of 8.0 inches, and an in-vacuum frequency of 221 Hz as a function of fluid density ρ for fluids with 3 different sound speeds as a function of fluid density for a first fluid 100 having an actual speed of sound of 40 m/s, a second fluid 101 having a speed of sound of 60 m/s and a third fluid 102 having a speed of sound of 80 m/s. As shown, the damping ratio associated with the fluid loading is fairly highly for this set of structural and fluid parameters. It should be appreciated by those skilled in the art that the damping ratio will be influenced by selection of the mass, radius, in-vacuum frequency and the fluid properties any vibrating plate densitometer. It is contemplated that the design of the of any VPD system would identify targeted characteristics that would drive a design study to optimize the targeted characteristics. Therefore, the damping ratios presented in this example of considered illustrative and not limiting in any way.

Referring to FIG. 13, there is shown FIG. 10 shows the normalized piston radius (ka), determined by the Eigenvalue solution of Equation 7 for the example disclosed above as a function of fluid density for a first fluid 100 having a speed of sound of 40 m/s, a second fluid 101 having a speed of sound of 60 m/s and a third fluid 102 having a speed of sound of 80 m/s fluids. It should be noted from the figure, the non-dimensional radius of plate 4 is well within the limits of the acoustic model (0<ka>10) of the impedance shown in FIGS. 2,3.

Referring back to FIG. 11, there is graphically depicted an example of leveraging an acoustic model of the present disclosure for the fluid-loading of a given vibrational mode of a given plate 4, in contact with a fluid 3 of known actual sound speed, to determine a relationship between the resonant frequency of the fluid-loaded plate and the actual fluid density. As part of the present disclosure, this example provides a means to determine the density of a fluid 3, based on determining the natural frequency of a fluid loaded vibrational plate 4. It should be noted that the theoretical solution utilized herein is an example of many methods to estimate the relationship described above, including empirical and computational methods. The methodology disclosed can provide a framework by which a particular a design process can be devised. Certain embodiments may require in-situ calibration to improve accuracy to determine a relationship between the resonant frequency of the fluid-loaded plate and the fluid density.

It can also be recognized with reference to FIG. 11 that the relationship between plate natural frequency and density is influenced by, and in dependence on, the speed of sound of the fluid. Since the speed of sound of liquids with entrained gases is highly sensitive to the entrained volumetric gas fraction, and entrained gas levels can be quite variable, the speed of sound of slurries can be quite variable as well. Therefore, the utility of the proposed vibrating plate densitometer 1 can be improved if used in conjunction with a device that measures the relevant speed of sound of the liquid 3, i.e. the speed of sound associated with frequencies at or near the resonant frequency of the vibrating plate 4. One such example of a sound speed measurement device that provides a measured sound speed in vessel is a SMARThatch® available from CiDRA Corporation. The relationship between speed of sound of a fluid with entrained gas and the gas void fraction is, among other things, a function of liquid density. As part of the present disclosure, combining a mixture density measurement with a speed of sound measurement can provide a more accurate determination of mixture density, non-aerated liquid or slurry density, and entrained gas measurement.

By way of example, for sound propagating within a conduit for which the wavelength is large compared to both fluid inhomogeneities and the cross-sectional length scale of the conduit, Wood's Equation relates mixture sound speed and density to the phase fractions, density and sound speeds of the components. The elasticity of the conduit also enters into Wood's Equation, given below for a thin-walled, circular cross section conduit of outer diameter D and wall thickness of t:

$$\frac{1}{{ρ}_{mix} {a}_{meas}^{2}} = {\sum }_{i = 1}^{N} \frac{{φ}_{i}}{{ρ}_{i} {a}_{i}^{2}} + \frac{D - t}{Et} \qquad ( Equation 13 )$$

Wherein the mixture density ρₘᵢₓ is given by:

ρₘᵢₓ=Σᵢ₌₁^{N}φᵢρᵢ (Equation 14)

The measured speed of sound aₘₑₐₛ is given by the following expression:

$${a}_{meas} = \sqrt{\frac{1}{{ρ}_{mix} ( {\sum }_{i = 1}^{N} \frac{{φ}_{i}}{{ρ}_{i} {a}_{i}^{2}} + \frac{D - t}{Et} )}} \qquad ( Equation 15 )$$

And the density ρ_{liq} of the non-aerated liquid phase is related to the mixture density ρ_{liq} and gas void fraction φ_{gas} as follows:

$${ρ}_{liq} ≅ \frac{{ρ}_{mix}}{1 - {φ}_{gas}} \qquad ( Equation 16 )$$

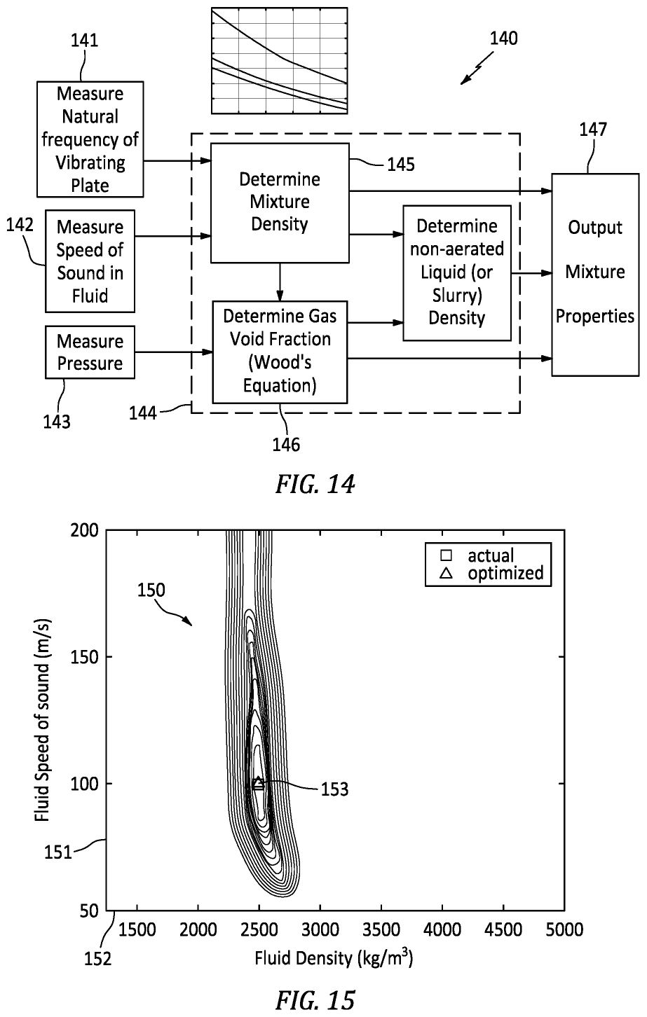

Referring to FIG. 14, there is shown a schematic representation of a method 140 of utilizing vibrating plate density measurement for an aeriated process fluid to determine fluid properties in conjunction with a process fluid sound speed measurement to provide aerated mixture density, non-aerated mixture density, and gas void fraction. At step 141, VPD 1 is used to measure the natural frequency of vibrating plate 4. At step 142, a device, such as that disclosed herein above, is used to measure the speed of sound of fluid 3. At step 143 a pressure sensor (not shown) is used to measure the pressure inside of the vessel. The measured natural frequency of plate 4, sound speed of fluid 3 and pressure are used as inputs into a computer processor 144. At step 145 the density of the fluid mixture 4 is determined using the methods herein described with reference to FIG. 11. At step 146 the gas void fraction of fluid 3 is determined using Equations 13-15. At step 147 the non-aerated liquid density is determined using Equation 16. At step 147 computer processor 144 is configured to output the various mixture properties of mixture density, gas void fraction and non-aerated liquid density to a user through a graphical user interface (not shown) or other output device.

In other embodiments of the present disclosure, the natural frequency of the fluid-loaded vibrational plate 4 can be determined using methods disclosed in more detail herein after. In such a method an equation of motion for the forced vibration of a damped vibrating plate can be used. The aforementioned effects of the reactive and the resistive components of the fluid loading are modelled as an effective acoustic mass (M_{eff}), an effective acoustic damping constant (b_{acoustic}) and structural damping constant (bₛ).

The equation of motion can next be considered for the forced vibration of a fluid loaded vibrating plate 4 embedded in a wall 2 exposed to a relatively high impedance fluid mixture 3 on one side and relatively low impedance mixture (e.g. a vacuum or gas filled region 8) on the other side. In this model, the vibrating plate 4 is forced by a drive coil. The effect of force (F) from the drive coil 5 on the vibrating plate can be found in accordance with the following relationship:

(M+M_{eff})\ddot{x}+(bₛ+b_{acoustic})\dot{x}+Kₛx=F (Equation 10)

Now consider the case in which the force from the drive coil is generated such that it is proportional to the velocity of vibrating piston. It can be assumed that the pick-off coil 6 of VPD 1 provides a signal proportional to the velocity of the plate 4. Thus, if the force supplied by the drive coil 5 is proportional to the signal from the pick-off coil 6, the equation of motion can be expressed as follows:

(M+M_{eff})\ddot{x}+(bₛ+b_{acoustic})\dot{x}+Kₛx=K_{feedback}\dot{x} (Equation 11)

As defined, a positive K_{feedback} represents a negative damping constant. This feedback term can be moved to the left-hand side of the equation and grouped with the always-positive, structural and acoustic damping terms. As known by those skilled in the art, the linear dynamic stability of this feedback-controlled system of VPD 1 will depend on the sign of the total damping term. A VPD 1 system will be linearly unstable for sufficient large drive gains of drive coil 5 such that:

(bₛ+b_{acoustic}−K_{feedback})<0 (Equation 12)

In accordance with the present disclosure, the result of adding a gain such that the VPD 1 system is linearly unstable will be that the amplitude of the oscillation of plate 4 at, or near, the natural frequency of the system will grow until non-linearities limit the amplitude of the oscillation in a limit cycle oscillation. The amplitude of the force applied by the drive coil can be controlled by feedback control module 10 based on a measured control parameter, such as the amplitude of the motion to ensure that, within the maximum allowable force limitations of the feedback signal, the limit cycle maintains the amplitude of the vibration at a target amplitude.

It should be appreciated by those skilled in the art that the method described immediately above is but one example of a method of using feedback control module 10 as a control system to induce and maintain a finite amplitude vibration of a vibrational mode of a plate in communication in which the frequency of the limit cycle is measured and a parameter of the control system which quantifies the acoustic damping is measured. The key aspects of any control system contemplated as part of the disclosure is that it induces a sustained vibrational response for which one can measure the frequency and that the control algorithm utilizes a measurable parameter of the feedback that enables identification of the acoustic damping. Other methods known to those skilled in the art of dynamical systems exist which provide feedback signals which result in a finite amplitude oscillation of a plate in communication with a fluid at, or near, it's natural frequency. These methods could include a range of other types of vibration sensors, including, but not limited to strain gauges, accelerometers, proximity sensors, optical position sensors, etc. These methods could include a range of linear and non-linear feedback control algorithms designed to induce vibration of the said VPD. Also, the feedback control system could include a range of actuation devices, including magnets, pressure modulation, fluidics, and other types of actuators. These methods are all considered within the scope of the invention described herein.

In other embodiments of a VPD system 1 of the present disclosure, the fluid density and fluid sound speed can be determined by measuring the natural frequency of the limit cycle oscillation and the feedback gain to the drive coil 5 required to destabilize the system. As disclosed herein above, structural damping and mechanical damping is often quite small, and as such the feedback gain required to destabilize the system is principally a measure of the acoustic damping. In cases where the structural, or mechanical damping is not small, its effect can be included to improve the estimate of the acoustic damping if needed. Also as disclosed herein above, the in-vacuum structural properties of the vibrating plate 4 are known and with reference to FIGS. 2, 3, a model for the acoustic mass loading and damping can be established, and an optimization process has been discovered to determine both the fluid sound speed and the fluid density based on minimizing errors in measured control parameters and predicted control parameters in terms of, for example, the predicted and measured natural frequency and the predicted and measured feedback gain required to destabilize the system. As part of such a VPD 1 system the natural frequency and the drive gain required to drive the vibrating plate 4 into a limit cycle are measured, a positive-definite error function can be defined as a function of the measured natural frequency and the measured drive gain, other known parameters, and trial values for fluid density and fluid speed of sound. An example of such an error function is given in accordance with the equation below:

$$error ( {ρ}_{trial} , {c}_{trial} ) = {( \frac{{K}_{drivefeedback} - π {a}^{2} {ρ}_{trial} {c}_{trial} θ ( {k}_{trial} a )}{2 {M}_{modal} {ω}_{measured}} )}^{2} + {( \frac{( {M}_{modal} + \frac{π {a}^{2} {ρ}_{trial} {c}_{trial} {ψ}_{0} ( {k}_{trial} α )}{ω} {ω}_{measured}^{2} - {K}_{s}}{{M}_{modal} {ω}_{measured}^{2}} )}^{2} \qquad ( Equation 17 )$$

Wherein kₜᵣᵢₐₗ is given in accordance with:

$${k}_{trial} = \frac{{ω}_{measured}}{{c}_{trial}} \qquad ( Equation 18 )$$

And wherein kₜᵣᵢₐₗ is the trial acoustic wave number associated with a measured frequency and a trial speed of sound of the fluid. Recalling also that the normalize piston radius is defined as ka, where k is the acoustic wavenumber and a is radius of the piston.

As part of the present disclosure, the trial values are used within an optimization process to converge from an initial estimate to an optimized value as determined based on an optimization process to drive the error to an acceptable low value. One example of such and optimization process is to evaluate the error function of Equation 17 over a range of trial values for the fluid density and the fluid speed of sound that span the actual values and select the combination of fluid density and speed of sound that results in the minimization of the error function over the range of trial values of process fluid density and speed of sound.

Referring to FIG. 15, there is shown a contour plot of the error function of Equation 17 generated for a simulated condition using the models disclosed herein above and plotted over a range of trial fluid densities 151 and trial sound speeds 152. In this particular simulation and using the models disclosed herein above, used an input process fluid sound speed of 100 m/s and input process fluid density to calculate a simulated measured natural frequency of 66.6 Hz and a simulated measured drive gain of 755 (Newtons/(meter/sec)) required to cause the vibration to become unstable. As shown, for the parameters evaluated, which are broadly representative of a wet concreate applications, minimization of the error function involving the measured and predicted natural frequency, and the measured and predicted drive gain, provides a unique solution for the process fluid density and speed of sound over the broad range of trial values assessed, wherein the minimized error function is depicted as optimized point 153, having a sound speed of 100 m/s and a density of 2500 kg/m³, in agreement with the input values. The existence of a unique solution for the sound speed and the density of the process fluid based on the error function defined is an important and advantageous aspect of this invention. This unique solution can be contrasted to situations in which the optimization does not results in a unique solution, i.e. for cases in which the optimization results in multiple combinations of sound speed and density which minimize the error function, impairing the ability to uniquely determine the sought parameters of the fluid.

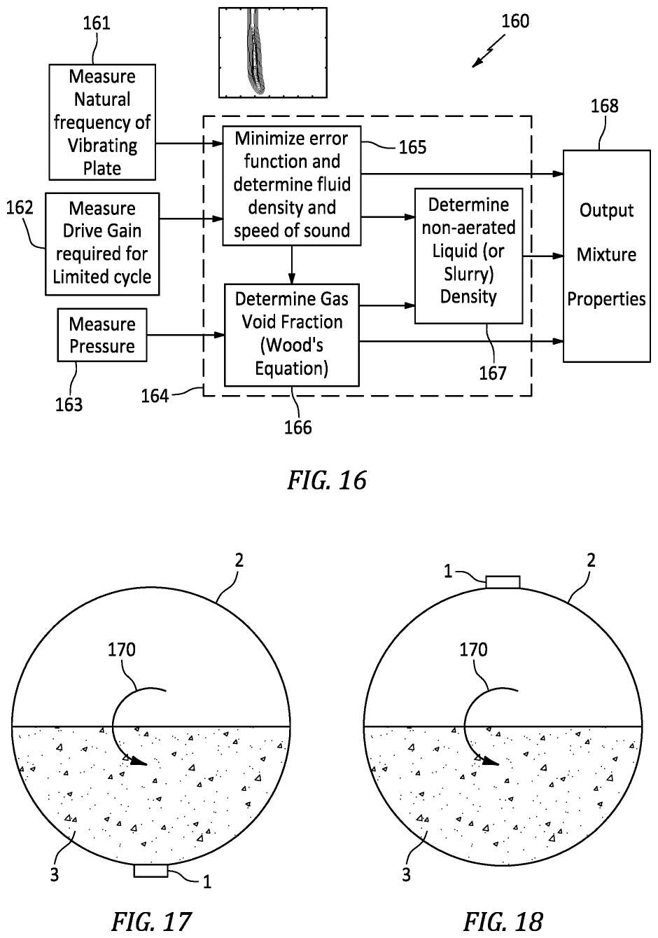

FIG. 16: shows a schematic of measurement process to interpret a measured natural frequency and a measured drive gain required to drive the system into a limit cycle to determine process fluid density and sound speed and then to utilize process fluid speed and density to determine Gas void fraction and non-aerated liquid density

Referring to FIG. 16 there is shown a schematic representation of a method 160 to interpret a measured natural frequency and a measured drive gain required to drive a VPD system 1 into a limit cycle to determine fluid properties such as determine process fluid density and sound speed and then to utilize process fluid sound speed and fluid density to determine gas void fraction and non-aerated liquid density. At step 161, VPD 1 is used to measure the natural frequency of vibrating plate 4 for an aerated process fluid. At step 162, VPD 1 is used to measure the feedback gain required to produce a limit cycle in the vibrating plate 4. At step 163 a pressure sensor (not shown) is used to measure the pressure inside of the vessel. The measured natural frequency of plate 4, measured feedback gain of drive coil 5 and pressure are used as inputs into a computer 164. At step 165 the density of the fluid mixture and the speed of sound of the fluid mixture is determined using Equation 17 and the methods disclosed related to FIG. 15. At step 166 the gas void fraction of fluid 3 is determined using Equations 13-15. At step 167 the non-aerated liquid density (i.e. the liquid portion of the aerated mixture) is determined using Equation 16. At step 168 computer 164 can output the various mixture properties of density of the aerated process fluid mixture, gas void fraction and non-aerated liquid density to a user through a graphical user interface (not shown) or other output device.

### Application of Apparatus to Rotating Vessels

The VPD system 1 of the present disclosure has many advantages over the prior art. With reference to FIGS. 17, 18 one such advantages of VPD system 1 is that it integrates within the exterior wall 2 of a vessel. As such, the fluid density measurement system of VPD system 1 it is well-suited measure aggressive slurries, such as wet concrete. As disclosed herein above, calibration of this device utilizes some knowledge of the mass of the vibrating plate 4. It should be appreciated that any build-up of concrete could cause errors in the interpreted fluid density and other parameters. For vessels that rotate in direction 170 (although either direction is contemplated), such as concrete trucks 220 (FIG. 22), a VPD system 1 and sensors installed in, or on, the wall 2 of the vessel could be exposed to varying conditions of being immerse under the fluid 3 while on the bottom of the tank and to being exposed to air while on the top of the tank. Such an embodiment provides an opportunity to measure the plate 4 of VPD 1 resonant frequency at each condition (exposed to fluid FIG. 17, and exposed to air FIG. 18), and relate the density of the wet concrete to the difference in the frequencies measured while submersed in the wet concrete at the bottom and while exposed to air at the top, thus providing a means to remove any effect associated with any build-up of material on the vibrating plate.

In other embodiments of VPD 1 plate 4 is can be comprised of an essentially rigid piston with a urethane or similar diaphragm. This particular embodiment offers a wide range of flexibility in selecting the diameter, mass and in-vacuum natural frequency of the piston. In addition, the natural frequency and the diameter of such embodiments can be selected to optimize several factors that can contribute to accuracy and robustness. As disclosed herein above, and from an acoustics perspective, the normalized piston radius is defined as the product of the wave number, k, and the radius of the piston, a. The following equation defines this relationship in terms of wavelength of sound travelling in the fluid 3:

$$ka = \frac{2 π}{λ} a = \frac{2 π a}{λ} = \frac{Circumference of Piston}{Acoustic Wavelength} \qquad ( Equaiton 19 )$$

With reference back to FIGS. 2, 3 it can be seen that that a VPD system 1 having a normalized piston radius in the approximate range of 1 to 3 is advantageous. Thus, it has been discovered that the acoustic wavelength should be on the order of the circumference of the piston. Additionally, the acoustic theory disclosed herein has been developed for a plate 3 radiating into an infinite space bounded by an infinite plane into which the plate is embedded. It should be appreciated that such a model suggests that the wavelength of the acoustics in the vessel should be small compared to the depth of the concrete within the vessel, such that effects of any reflections from any free surface on any other abrupt change in acoustic impedance are minimized. It should also be noted that, the acoustic theory of the present disclosure assumes that the acoustics propagate through an essentially homogeneous medium. This assumption implies that the acoustic wavelength is long compared to any inhomogeneities in the concrete, such as air bubbles and aggregate particles within the concrete. One implication of these length scale requirements is that the circumference of the piston should also be large compared to the length scale of any of said inhomogeneities.

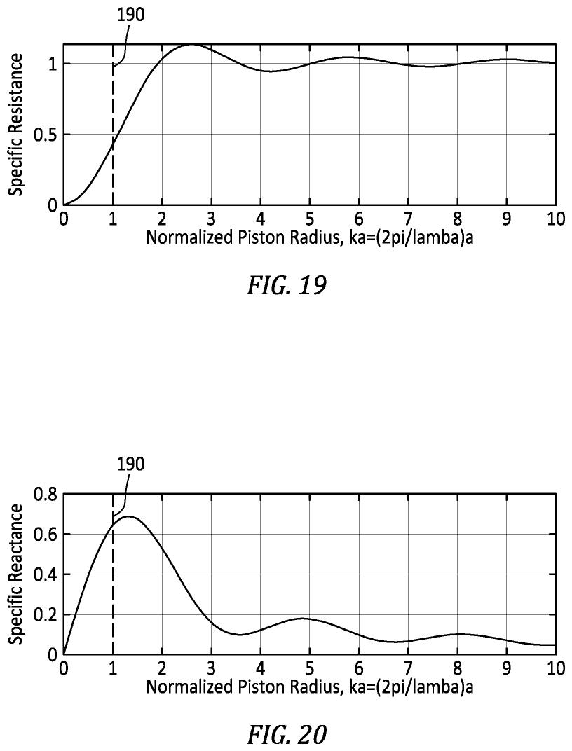

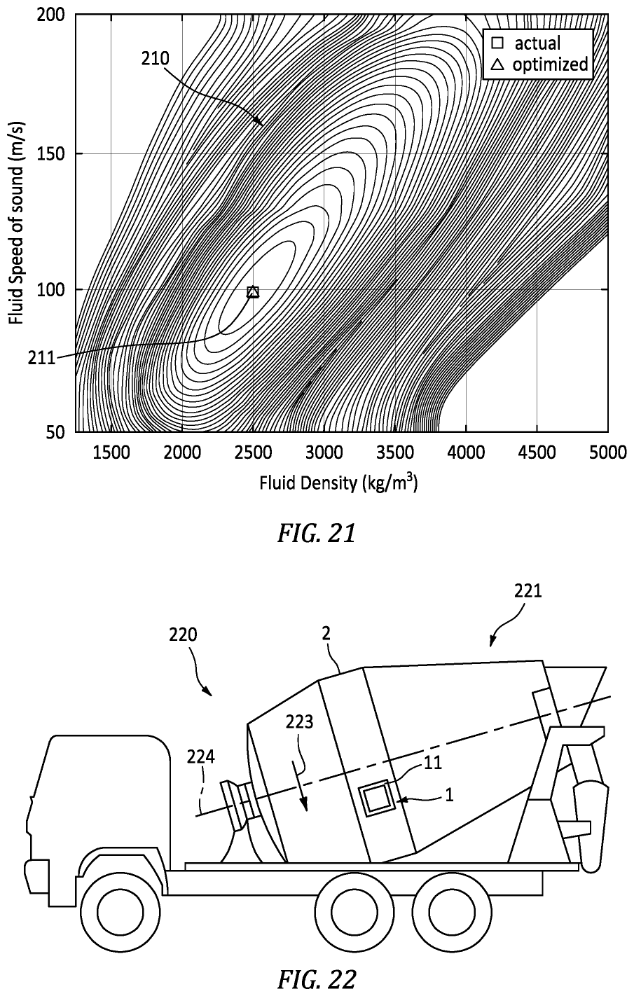

Referring next to FIGS. 19, 20 and with further reference back to FIG. 1, an example embodiment of VPD 1 having a plate 4 with a diameter of 1.5 inches and a mass of 0.07 kg. The plate diameter of 1.5 inches corresponds to normalized piston radius near unity 190 and an in-vacuum natural frequency of 1000 Hz, operating in a fluid with a density of 2500 kg/m³ with a speed of sound of 100 m/sec. The circumference of the plate 4 is approximately 5 inches, which is relatively long compared to expected inhomogeneities in concrete, but relatively short compared to the expected depth of concrete within a concrete mixer, suggesting that this design may be appropriate for the expected concrete sound speed of 100 m/sec. FIG. 19 shows that the specific resistance in this embodiment is approximately 0.45 and FIG. 20 shows that the specific reactance is approximately 0.65. Referring to FIG. 21, there is shown the optimization plot 210 of an error function of Equation 17 based on the measured natural frequency and the measured feedback gain required to destabilize the embodiment of vibrating plate densitometer 1 disclosed immediately herein above. The figure shows optimal point 211 as a unique minimal associated with the input fluid density of 2500 kg/m³ and fluid speed of sound 100 m/s. The optimization function of Equation 17 is based on the measured natural frequency and the measured feedback gain required to destabilize the vibrating plate densitometer 1.

### Application of Vibrating Plate Densitometer in a Cement Truck

Referring next to FIG. 22 and with reference back to FIG. 1, in operation VPD 1 can be used in operation to provide information about the density and speed of sound of concrete in real time in a concrete transporting truck 220. Truck 220 includes agitating vessel 221 having a wall 2 within which VPD 1 is mounted. Agitating vessel 221 rotates in the direction of arrow 223 about axis 224 to mix and agitate a concrete mixture 3 within the agitating vessel during transportation to a job site. VPD 1 is mounted in an opening of wall 2 by frame 11 such that an inside surface of plate 4 is positioned in the interior volume of agitation vessel 221. The inside surface of plate 4 is in contact with concrete mixture 3 as the agitation vessel 221 rotates through at least the bottom portion of its rotation. In this particular embodiment, parameters related to the concrete mixture 3 can be determined as disclosed herein above such as the density, amount of entrained air, gas volume fraction and speed of sound. VPD 1 can include communication devices (not shown) that can communicate the parameters to a driver of truck 220 or other person or system such as a central database, a construction site worker or the like. Such communication devices can interact using an known method such as wired, wireless, cellular, Bluetooth, Wi-Fi and the like.

All of the methods disclosed and claimed herein can be made and executed without undue experimentation in light of the present disclosure. While the apparatus and methods of this disclosure have been described in terms of preferred embodiments, it will be apparent to those of skill in the art that variations may be applied to the methods and in the steps or in the sequence of steps of the method described herein without departing from the concept, spirit and scope of the disclosure. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the disclosure.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated other The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations

While the foregoing is directed to embodiments of the present disclosure, other and further embodiments of the disclosure may be devised without departing from the basic scope thereof, and the scope thereof is determined by the claims that follow.

1. A fluid density measurement device comprising:
a housing;
a plate mounted to the housing around a periphery of the plate forming an interior space within the housing;
a first side of the plate is configured to be placed in fluid communication with a first fluid to produce a fluid loaded plate;
an actuator coupled to the plate and configured to drive the fluid loaded plate in a transverse direction and produce a vibratory motion of the fluid loaded plate in the transverse direction;
a sensor configured to detect the vibratory motion of the fluid loaded plate;
the actuator further configured to produce the vibratory motion at or near a natural frequency of the fluid loaded plate; and
a computer processor configured to determine a density of the first fluid based at least in part in dependance of the natural frequency of the fluid loaded plate.

2. The fluid density measurement device of claim 1 further comprising:
a feedback control system in communication with the actuator and the sensor configured to control the actuator to generate the vibratory motion of the fluid loaded plate at or near the natural frequency of the fluid loaded plate in response to a measurement signal of the sensor;
the computer processor further configured to:
determine a simulated natural frequency of the fluid loaded plate; and
determine the density of the first fluid in dependance of a measured natural frequency of the fluid loaded plate and the simulated natural frequency of the fluid loaded plate.

3. The fluid density measurement device of claim 2 further comprising:
a sound speed measurement device configured to determine a measured sound speed of the first fluid; and
the computer processor is further configured to determine the density of the first fluid in dependence of the measured natural frequency of the fluid loaded plate and the measured sound speed of the first fluid.

4. The fluid density measurement device of claim 3 further comprising the computer processor is configured to determine a gas void fraction of the first fluid in dependence of the measured sound speed of the first fluid and the density of the first fluid.

5. The fluid density measurement device of claim 1 further comprising:
a feedback control system in communication with the actuator and the sensor configured to control the actuator to generate the vibratory motion in the fluid loaded plate in response to a measurement signal of the sensor and to measure a measured control parameter required to sustain the vibratory motion of the fluid loaded plate at or near the natural frequency of the fluid loaded plate;
the computer processor further configured to:
use a model to relate at least one of the density of the first fluid and a sound speed of the first fluid to a predicted control parameter required to sustain the vibratory motion of the fluid loaded plate at or near the natural frequency of the fluid loaded plate;
use the model to relate at least one of the density of the first fluid and the sound speed of the first fluid to a predicted natural frequency of the fluid loaded plate; and
compare the predicted control parameter to the measured control parameter and the predicted natural frequency to the natural frequency and to determine at least one of an actual sound speed of the first fluid and an actual fluid density of the first fluid.

6. The fluid density measurement device of claim 5 wherein the computer processor is further configured to determine an entrained air content of the first fluid in dependence of at least one of the sound speed of the first fluid and the density of the first fluid.

7. The fluid density measurement device of claim 2 further comprising a second fluid disposed with the interior space and wherein the second fluid has a second impedance that is much lower than a first impedance of the first fluid.

8. The fluid density measurement device of claim 2 wherein the actuator comprises a drive coil and the sensor comprises a pick-off coil.

9. The fluid density measurement device of claim 2 wherein the vibratory motion is driven to a limit cycle oscillation.

10. The fluid density measurement device of claim 1 further comprising a frame attached to the housing and configured to be mounted to an opening in a vessel.

11. A fluid density measurement system comprising:
a vessel having an outer wall and a first fluid disposed therein;
a plate positioned in an opening in the outer wall having a first side placed in fluid communication with the first fluid;
an actuator coupled to the plate and configured to drive the plate in a transverse direction and produce a vibratory motion of the plate in the transverse direction;
a sensor configured to detect the vibratory motion of the plate;
the actuator further configured to produce the vibratory motion at or near a natural frequency of the plate; and
a computer processor electrically coupled to the actuator and the sensor and configured to determine a density of the first fluid based at least in part in dependance of the natural frequency of the plate.

12. The fluid density measurement system of claim 11 further comprising:
a housing;
a frame mounted to the housing;
the plate mounted to the housing around a periphery of the plate forming an interior space within the housing; and
the frame mounted to the outer wall.

13. The fluid density measurement system of claim 11 further comprising:
a feedback control system in communication with the actuator and the sensor configured to control the actuator to generate the vibratory motion of the plate at or near the natural frequency of the plate in response to a measurement signal of the sensor;
the computer processor further configured to:
determine a simulated natural frequency of the plate; and
determine the density of the first fluid in dependance of a measured natural frequency of the plate and the simulated natural frequency of the plate.

14. The fluid density measurement system of claim 12 further comprising:
a sound speed measurement device configured to determine a measured sound speed of the first fluid; and
the computer processor is further configured to determine the density of the first fluid in dependence of the natural frequency of the plate and the measured sound speed of the first fluid.

15. The fluid density measurement system of claim 14 further comprising the computer processor is configured to determine a gas void fraction of the first fluid in dependence at least one of the measured sound speed of the first fluid and the density of the first fluid.

16. The fluid density measurement system of claim 11 further comprising:
a feedback control system in communication with the actuator and the sensor configured to control the actuator to generate the vibratory motion in the plate in response to a measurement signal of the sensor and to measure a measured control parameter required to sustain the vibratory motion of the plate at or near the natural frequency of the plate;
the computer processor further configured to:
use a model to relate at least one of the density of the first fluid and a sound speed of the first fluid to a predicted control parameter required to sustain the vibratory motion of the plate at or near the natural frequency of the plate;
use the model to relate at least one of the density of the first fluid and the sound speed of the first fluid to a predicted natural frequency of the plate; and
compare the predicted control parameter to the measured control parameter and the predicted natural frequency to the natural frequency and to determine at least one of an actual sound speed of the first fluid and an actual fluid density of the first fluid;
a second fluid disposed with the interior space and wherein the second fluid has a second impedance that is much lower than a first impedance of the first fluid;
the actuator and the sensor are disposed within the interior space; and
wherein the actuator comprises a drive coil and the sensor comprises a pick-off coil;
wherein the computer processor is further configured to determine an entrained air content of the first fluid in dependence of at least one of the sound speed of the first fluid and the density of the first fluid; and
wherein the vibratory motion is driven to a limit cycle oscillation.

17. (canceled)

18. (canceled)

19. (canceled)

20. A method of determining a density of a process fluid comprising:
providing a vessel having an exterior wall and the process fluid disposed therein;
positioning a plate in the exterior wall having a first side of the plate in fluid communication with the process fluid;
producing a vibratory motion of the plate in a transverse direction;
detecting the vibratory motion of the plate;
producing the vibratory motion at or near a natural frequency of the plate; and
determining a density of the process fluid based at least in part in dependance of the natural frequency of the plate.

21. The method of determining a density of a process fluid of claim 20 further comprising:
coupling at least one sensor and an actuator to the plate;
providing a feedback control system in communication with the sensor;
controlling the vibratory motion of the plate at or near the natural frequency of the plate in response to a measurement signal from at least one sensor;
determining a simulated natural frequency of the plate;
measuring a natural frequency of the plate using the at least one sensor; and
determining the density of the process fluid in dependance of a measured natural frequency of the plate and the simulated natural frequency of the plate.

22. The method of determining a density of a process fluid of claim 21 further comprising:
providing a sound speed measurement device and determining a measured sound speed of the process fluid; and
determining the density of the process fluid in dependence of the measured natural frequency of the plate and the measured sound speed of the process fluid.

23. The method of determining a density of a process fluid of claim 22 further determining a gas void fraction of the process fluid in dependence of at least one of the measured sound speed of the process fluid and the density of the process fluid.

24. The method of determining a density of a process fluid of claim 20 further comprising:
coupling at least one sensor to the plate;
providing a feedback control system in communication with the at least one sensor;
generating the vibratory motion in the plate in response to a measurement signal from the at least one sensor
measuring a measured control parameter required to sustain the vibratory motion of the plate at or near the natural frequency of the plate;
using a model to relate at least one of the density of the process fluid and a sound speed of the process fluid to a predicted control parameter required to sustain the vibratory motion of the plate at or near the natural frequency of the plate;
using the model to relate at least one of the density of the process fluid and the sound speed of the process fluid to a predicted natural frequency of the plate;
comparing the predicted control parameter to the measured control parameter and the predicted natural frequency to the natural frequency; and
determining at least one of an actual sound speed of the process fluid and an actual fluid density of the process fluid.

25. The method of determining a density of a process fluid of claim 24 further comprising determining an entrained air content of the process fluid in dependence of at least one of the actual sound speed of the process fluid and the actual fluid density of the process fluid.

26. The method of determining a density of a process fluid of claim 21 further comprising driving the vibratory motion to a limit cycle oscillation.

27. (canceled)

28. (canceled)

29. (canceled)
